(19) United States
(12) Patent Application Publication
(10) Pub. No.: US 2013/0254415 A1
(43) Pub. Date: Sep. 26, 2013

(54) ROUTING REQUESTS OVER A NETWORK

(71) Applicants: F. Brian Fullen, Plano, TX (US); Agrawal Chiranjeev, Bangalore (IN); Kumar J.V. Kishore, Bangalore (IN); Keri R. Quinn, The Colony, TX (US)

(72) Inventors: F. Brian Fullen, Plano, TX (US); Agrawal Chiranjeev, Bangalore (IN); Kumar J.V. Kishore, Bangalore (IN); Keri R. Quinn, The Colony, TX (US)

(21) Appl. No.: 13/430,161

(22) Filed: Mar. 26, 2012

(51) Int. Cl. G06F 15/173; G06F 15/16

(52) U.S. Cl. 709/230; 709/239

(57) ABSTRACT

Routing a request in a network that has a repository of information about dynamically changing network paths between nodes within the network may include, with a requesting node, consulting the repository and sending a request to an indirectly connected destination node within the network though an end-to-end route based on information within the repository.

### BACKGROUND

Diameter protocol is for peer-to-peer network architectures where a network node may function as a client, server, or agent depending on the application. Nodes that are functioning as agents relay messages, requests and answers between other nodes that are acting as server and client.

Generally, in networks using Diameter protocol, when an agent receives a message intended for a destination other than itself or its directly connected peers, the agent forwards the message to one of its directly connected peers to route the message towards the final destination in an indeterminate manner until the request reaches its destination.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an illustrative network, according to principles described herein.

FIG. 2 is a diagram of an illustrative repository, according to principles described herein.

FIG. 3 is a diagram of an illustrative flowchart of a method for routing a request over a network, according to principles described herein.

FIG. 4 is a diagram of an illustrative flowchart for routing a request over a network, according to principles described herein.

FIG. 5 is a diagram of an illustrative network, according to principles described herein.

### DETAILED DESCRIPTION

The present specification describes principles including, for example, a method for routing a request in a network that has a repository of information about dynamically changing network paths between nodes within the network. Examples of such a method include consulting the repository with a requesting node and then sending a request to an indirectly connected destination node within the network from the requesting node though an end-to-end route based on the information within the repository.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

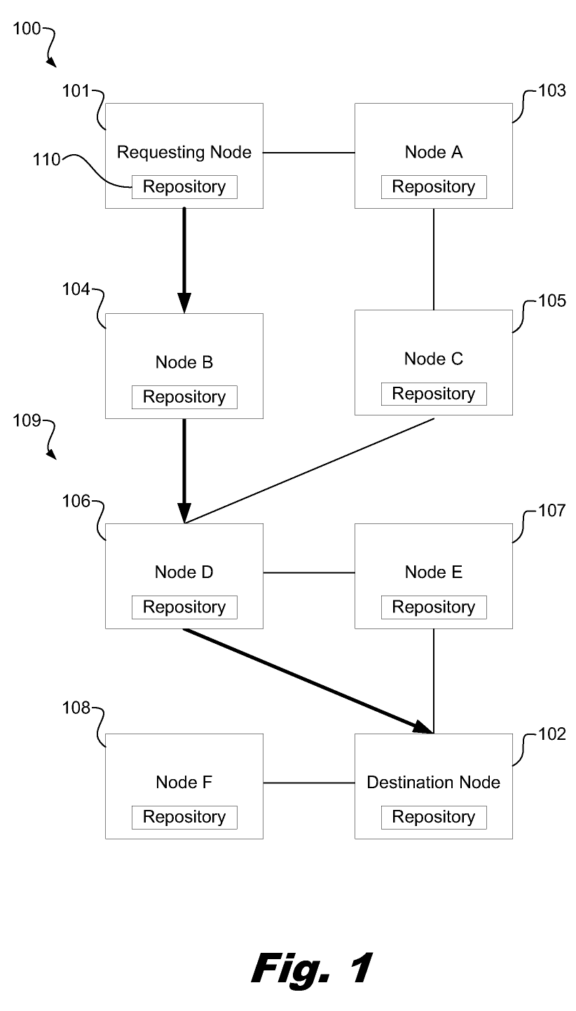

FIG. 1 is a diagram of an illustrative network (100), which may be any type of network. In some examples, the network (100) may be a network type from the following non-exhaustive list, including local area networks, wide area networks, wireless networks, virtual private networks, computer networks, telecommunication networks, the internet, peer to peer networks, Internet Protocol (IP) based network, and combinations thereof. In some examples, the network has an architecture suitable for peer-to-peer networks where the nodes may function as servers, clients, or agents depending on the application. In some examples, the network may follow an authentication, authorization, and accounting protocol, such as Diameter.

In the example of FIG. 1, a requesting node (101) may be indirectly connected to a destination node (102) through a plurality of network paths. Nodes A (103) and B (104) may be directly connected to the requesting node (101). Nodes D (106), E (107), and F (108) may be directly connected to the destination node (102). Consequently, a request message originating with requesting node (101) to be sent to the destination node (102) may take various network paths over nodes A, B, C, D, and E.

However, in the illustrated example, an optimized route (109) over nodes B (104) and D (106) has the minimum number of transport connections between the requesting node (101) and the destination node (102). Further, in some examples, an optimized route may be determined as that route having a minimum latency to arrive at the destination node. Other factors may be considered when determining an optimal route.

In some examples, a network path may include physical connections between nodes. In some examples, the network path may have transport connections established between nodes.

In the example of FIG. 1, each node in the network has access to a network-wide repository (110) that contains information about the transport connections within the network. In some examples, this repository may be kept at a single location with which all the nodes can communicate. In such examples, the nodes share the common repository that includes information about the transport connections within the network. The repository within the network contains information about the network's transport connections, and network nodes may consult with this repository prior to sending at least some request messages.

In other examples, a copy of this repository may be stored locally at each node. In such examples, the network nodes may be programmed to regularly or periodically update the information in their respective repositories to keep up with changes occurring in the network. For example, the network nodes may update their repositories as transport connections between the nodes within the network are made and unmade.

In the example of FIG. 1, the requesting node (101) may be acting as a client that sends a request message to the destination node (102) that is acting as a server. Alternatively, the requesting node (101) may be acting as a server that is sending a response message to a destination node (102) acting as a client. The intermediary nodes (Nodes A-E) may thus function as agents that may relay the messages between the requesting and destination nodes (102).

In examples where multiple nodes act as servers, multiple nodes may establish transport connections without the involvement of a centralized node. Also, transport connections may be unmade without the involvement of a centralized node. Further, the making and undoing of transport connections may be dynamic, such that the number of paths and/or transport connections within the network (100) is unpredictable. The principles described herein provide the requesting nodes with information to route request messages over an end-to-end route that is optimized for each request message. In some examples, the route is chosen to have a minimal number of transport connections, thereby speeding up the delivery of the request message and freeing up the resources of other intermediary nodes. In other examples, the route is chose to have minimal latency so that communications within the network occur as quickly as possible. In some cases, the route with the fewest number of transport connections may not also be the route with the smallest latency.

In some examples, the nodes in the network form the transport connections between themselves. A node acting as a server may send a request message to another node that acts as a client to establish a transport connection. Generally, the node acting as a client accepts the request message before the transport connection is made. The transport connection may be terminated by either node. Generally, a transport connection allows for direct two way communication between the two nodes, and transport connections may be used for end-to-end routing of a request message.

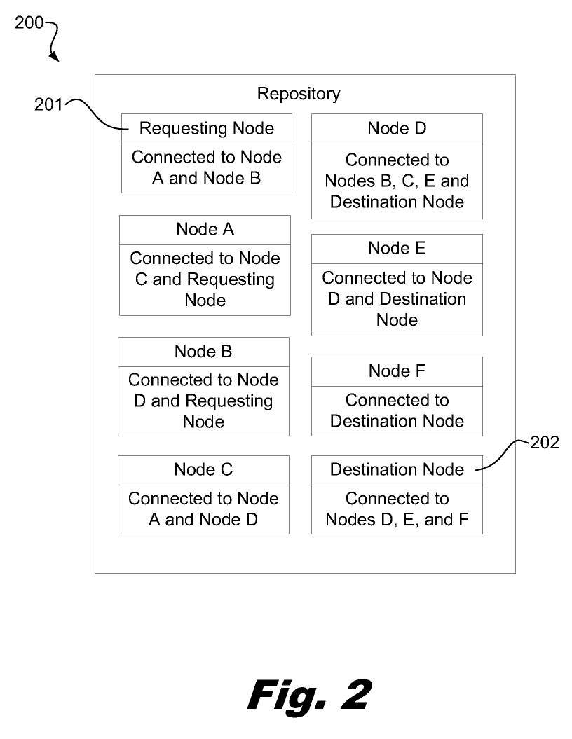

FIG. 2 is a diagram of an illustrative repository (200), according to the principles described herein. The repository (200) may have a table that includes some or all of the nodes in the network. In the example of FIG. 2, the repository (200) contains information about the transport connections established by the requesting node, destination node, and nodes A-F.

For example, memory in the repository may have a table (201) that identifies that the requesting node is connected to Nodes A and B. Also, the repository may have another table (202) that identifies that the destination node is connected to Nodes D, E, and F. Upon consulting the repository, the requesting node may also identify that Nodes B and D are connected to each other, thereby completing a route from the requesting node to the destination node.

Upon further consultation with the repository, a processing element of the requesting node may determine that the route from the requesting node over Nodes B and D to the destination node is the route with the minimal number of transport connections, and thereby select that route when sending the request message. Thus, the requesting node may deterministically route the request message over a route that meets criteria set forth by the requesting node. In some examples, the criteria may be a route over a minimum number of transport connections, a minimum latency before arriving at the destination node, other criteria, or combinations thereof.

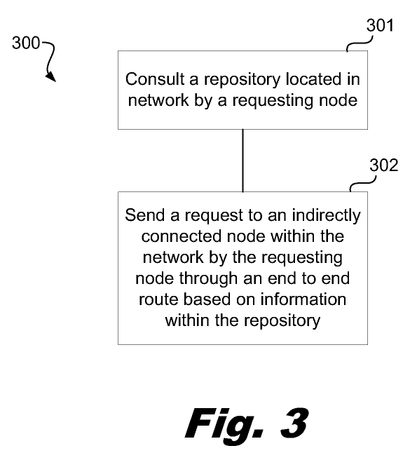

FIG. 3 is a diagram of an illustrative method (300) for routing a request over a network. The method may include a request node consulting (301) a repository located in a network. The requesting node then sends (302) a request to an indirectly connected node within the network through an end-to-end route that reaches the destination node based on information within the repository.

In some examples, sending the request may include sending the request through an authentication, authorization, and accounting protocol, such as Diameter. Also, in some examples, the method may further include updating the repository with real time information about transport connections between the requesting node and directly connected nodes. Also, the method may include receiving updated information about transport connections of indirectly connected nodes in the network or about transport connections of nodes directly connected to the requesting node. In examples, where the requesting node receives updates about transport connections in the network, the requesting node may update the repository to reflect real time information.

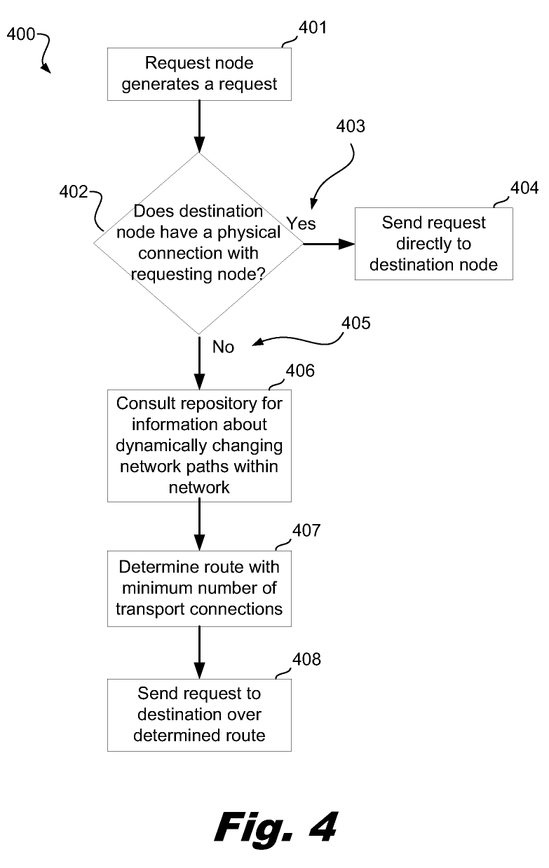

FIG. 4 is a diagram of an illustrative flowchart (400) for routing a request message over a network, according to principles described herein. As used herein, “directly” connected nodes are nodes that share a direct connection with each other absent any intervening nodes. Nodes are “indirectly” connected if they must use a connection with one or more intervening nodes to communicate with each other.

According to the example of FIG. 1, the requesting node may generate (401) a request message for a destination node on the network. Before sending the request message, the requesting node may determine (402) if the requesting node is directly connected through a physical connection to the destination node. If the requesting node is directly connected (403) to destination node through a physically connection, the requesting node may simply send (404) the request message over the physical connection.

If the destination node and the requesting node are indirectly connected (405), the requesting node may consult (406) the repository of dynamically changing network paths. With the information from the repository, the requesting node may determine (407) a route between the requesting node and the destination node based on some performance criterion such as fewest intervening nodes and connections or lowest latency. The requesting node then sends (408) the request message over the determined route to the destination node.

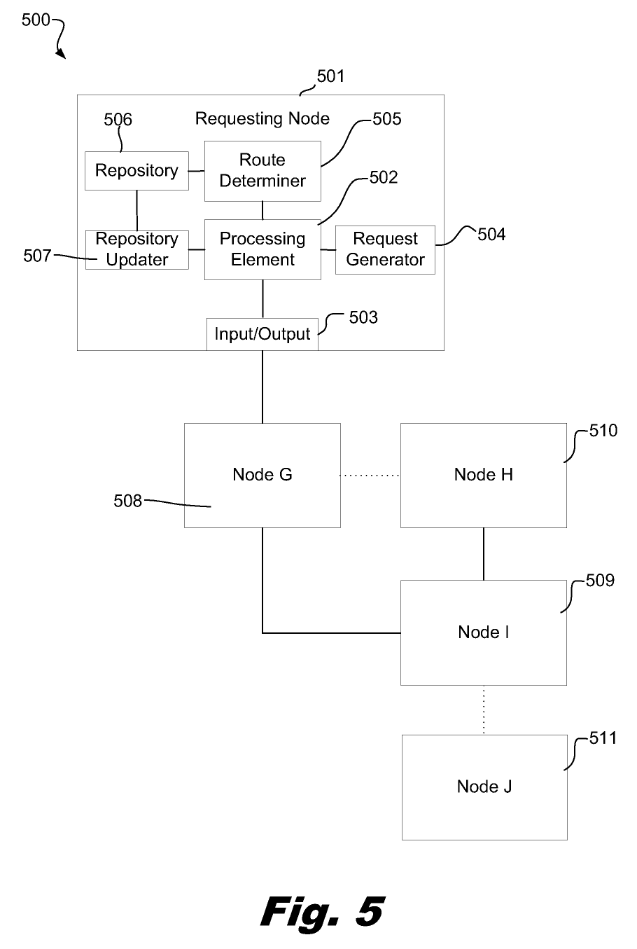

FIG. 5 is a diagram of an illustrative network (500), according to principles described herein. In the example of FIG. 5, the requesting node (501) has a plurality of components including a processing element (502) that controls at least some of the functions of the requesting node (501). The processing element (502) may be in communication with an input/output (503) of the requesting node where requests, messages, answers, and other information may be received by the requesting node (501). Also, the processing element (502) may instruct that the requests, messages, answers, or other information is sent from the requesting node through the input/output (503).

Further, in the example of FIG. 5, the processing element (502) is in communication with a request generator (504) that processes request messages to be sent from the requesting node (501). The processing element (502) is also in communication with a route determiner (505) that accesses information from a repository (506) that contains network-wide information about dynamically changing transport connections within the network (500). The processing element (502) may be in communication with a repository updater (507) that updates the information in the repository as the information is received by the requesting node (501).

In some examples, the repository (506) may have executable code that allows the repository to update itself, or the processing element (502) may update the repository (506). In some examples, the route determiner (505) and/or the request generator (504) may be part of the processing element (502).

Node G (508) may be directly connected to the requesting node (501). Node G (508) may also be directed connected to Node I (509). Also, Node G (508) may be physically connected to Node H (510) through cables and routes within the network (500), but no transport connection may be established. Further, Node I (509) may be physically connected to Node J (511), although no transport connection may be established between them.

In some examples, if the requesting node (501) desires to send a request message to Node H (510), the route determiner (505) consults the repository (506) to determine an optimal route, for example, with the fewest transport connections. In the example, of FIG. 5, the route with the fewest transport connections may be through Node G (508) and Node I (509). In some examples, the request message is an authentication, authorization, and accounting request message, such as a Diameter request message. Further, the transport connections in the network (500) may be connections operating according to the Diameter protocol.

Once the request message reaches Node G (508), a processing element may determine that Node G (508) is not the final destination, and Node G (508) may also determine an optimal route to send the request message to its destination. Node G (508) consults its own network-wide repository of network transport connections to deterministically route the request message. In some examples, transport connections may be established within the network while the request message is in route to its destination. In such an example, an agent node may alter the route that the requesting node may have originally determined as an optimal route because of changes in the network (500) since the request message was originally sent. The determined route may be altered by the addition or termination of transport connections. Thus, in some examples, the request message may be deterministically routed to account for real time network path changes.

In some examples, if Node G (508) establishes a transport connection with Node H (510), Node G (508) may broadcast to the rest of the network its new transport connection with Node H (510). In some examples, Node G (508) may broadcast all of its connections at the same time or just the change in its transport connections. The requesting node (501) receives the broadcast at the input/output (503) and passes the message to its processing element (502). In the illustrated example, the processing element (502) forwards the information to the repository updater (507). The updater (507) is programmed to update the information in the repository (506) with the information that it receives from the processing element. In some examples, the repository updater (506) has logic that allows it to filter information irrelevant to the transport connections within the network (500).

With the updated information about a newly established transport connection between Node G (508) and Node H (510), if the requesting node (501) desires to send a request message to Node H (510), the route determiner (505) may consult the repository (506) that contains the updated information about the transport connection between Node G (508) and Node H (510). With access to the updated information, the route determiner (505) may deterministically route the request message through Node G (508) directly to Node H (510).

In some examples, if Node I (509) and Node J (511) established a transport connection, Node I (509), Node J (511), or both may broadcast information about their newly formed transport connection over the network such that the information is received by the requesting node (501).

If the transport connection between Node H (510) and Node I (509) is terminated, Node I (509) may broadcast the termination as an update to the rest of the network. The termination of a transport connection may be planned or spontaneous. In some examples, the transport connection may become temporarily unavailable, such as through a connectivity loss due to a physical or network failure. A transport connection may also be lost if Node H (510) is physically removed from the network (500). In examples where the transport connection is planned to be disconnected at a specific time (such as for maintenance) or after a specific event, either Node I (509), Node H (510), or both may broadcast alerts about a planned termination of the transport connection prior to the disconnection. In some examples, the alert may be followed by a confirmation that the transport connection between Node I (509) and Node H (510) is terminated.

In an example, where Node H is physically removed from the network and physically reconnected to the network, Node H (510) may establish a transport connection with Node I (509). After establishing the transport connection with Node I (509), Node H (510) may request information from Node I (509) about the transport connections in the network (500) to update Node H's repository. In alternative examples, Node H (510) may broadcast a query over the entire network asking about each node's transport connections.

If the transport connection between Node G (508) and the requesting node (501) is terminated, the processing element (502) will instruct the repository updater (506) to update the repository (506) about the change.

In some examples, the requesting node (501) may actively monitor the transport connections within the network (500). The requesting node (501) may monitor the existing connections by periodically broadcasting a query over the network (500) asking for updated information. In some examples, the requesting node (501) may request that the nodes to which it is connected notify it when connections are made or unmade. Further, the requesting node (501) may subscribe to notifications offered by nodes within the network (500) concerning their transport connection status.

To determine which nodes are directly connected to itself, a requesting node may send a request message out in all directions. Those nodes that receive the request message may answer the request message with a packet that contains the answering node's address and/or other forms of identification. The answering node may also request the address and/or other forms of identification of the requesting node. As the requesting and answering nodes receive this information, they update their repositories. Further, the request message from the requesting node may additionally ask for information about the answering node's other transport connections. If the answering node also knows to whom it is connected, the answering node may reply by sending that information. If the answering node is not in possession of the requested information at the time that the request message is received or the information is likely outdated, the answering node may send a similar query to its directly connected nodes to gather information to satisfy the request message.

After the requesting node receives an answer from the answering node, the requesting node may send an additional request message instructing the answering node to notify the requesting node in the event that a transport connection change occurs to the answering node. The additional request message may also contain instructions for the answering node to relay any information that it receives about the establishment or termination of any other transport connections in the network.

By following the principles described herein, a requesting node or agent node may minimize the time lapse between sending an original request message and the request message's receipt at destination node. In some examples, a request message may be routed over a single agent node before reaching its destination.

In the event that more than one route to a destination node contains the same minimal number of intervening transport connections, the route determiners may account for other factors from the following non-exhaustive list, such as latency, the number of available ports at a particular node along one of the routes, the number of other transport connections established with a particular node, a history of reliability of a particular node, a processing speed of a particular node, activity of the network, or combinations thereof. In such examples, these other factors may act as tie breakers. In other examples, the route determiners may randomly choose between the route with equal intervening transport connections or resort to a round robin scheme between these routes. In other examples, the route determiner may predominately select a route based on factors from the aforementioned non-exhaustive list.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for routing a request, comprising:
with a requesting node, consulting a repository located in a network, said repository comprising information about dynamically changing network paths between nodes within said network; and
with the requesting node, sending a request to an indirectly connected destination node within said network though an end-to-end route based on information within said repository.

2. The method of claim 1, wherein said route contains a minimum of transport connections between said requesting node and said indirectly connected destination node.

3. The method of claim 1, wherein sending said request comprises sending said request under Diameter protocol.

4. The method of claim 1, wherein said requesting node contains said repository.

5. The method of claim 1, wherein said repository is a network-wide repository that contains updated information about transport connections between nodes within said network.

6. The method of claim 1, further comprising updating said repository with real time information about transport connections between said nodes in said network.

7. The method of claim 1, further comprising receiving updated information about transport connections of indirectly connected nodes in said network.

8. The method of claim 1, further comprising receiving updated information about transport connections of a directly connected node.

9. A node, comprising:
a network-wide repository comprising a status of changing network paths within a network, and
at least one component programmed to:
receive updated information about said network paths; and
update said repository as updated information is received by said node;
wherein said node can operate as any of a client, server and agent within the network.

10. The node of claim 10, further programmed to send a request to an indirectly connected destination node along a route based on information in said repository.

11. The node of claim 11, wherein said route contains a minimum of transport connections between said node and said indirectly connected destination node.

12. A computer program product, comprising:
a tangible computer readable storage medium, said computer readable storage medium comprising computer readable program code embodied therewith, said computer readable program code comprising:
computer readable program code to consult with a network-wide repository in a network, said repository containing information about dynamically changing transport connections within said network; and
computer readable program code to send a request to an indirectly connected destination node along a route based on information from said repository.

13. The computer program product of claim 13, wherein said route contains a minimum of transport connections to said indirectly connected destination node.

14. The computer program product of claim 13, further comprising computer readable program code to receive updated information about said dynamically changing transport connections and to update said repository.

15. The computer program product of claim 13, further comprising computer readable program code to maintain said repository.
